(19) United States
(12) Patent Application Publication
(10) Pub. No.: US 2024/0002271 A1
(43) Pub. Date: Jan. 4, 2024

(54) METHOD AND DEVICE FOR DRAWING THIN GLASS RIBBONS

(71) Applicant: SCHOTT AG, Mainz (DE)

(72) Inventors: Holger WEGENER, Alfeld (DE); Rainer SCHWERTFEGER, Eschershausen (DE); Stefan GIEHL, Alfeld (DE); Karl-Heinz SCHMIDT, Grünplan (DE)

(73) Assignee: SCHOTT AG, Mainz (DE)

(21) Appl. No.: 18/465,879

(22) Filed: Sep. 12, 2023

Related U.S. Application Data
(63) Continuation of application No. PCT/EP22/55226, filed on Mar. 2, 2022.

(30) Foreign Application Priority Data
Mar. 12, 2021 (DE) 10 2021 106 106.7

(51) Int. Cl. C03B 17/06

(52) U.S. Cl. CPC C03B 17/068

(57) ABSTRACT

A device for drawing glass ribbons is provided. The device includes a drawing tank and a nozzle in the drawing tank. The drawing tank holds a glass melt. The nozzle has a nozzle slot through which the glass melt emerges downward. The nozzle slot has two ends, a length, and a width, the length being greater than the width. The nozzle slot is curved downward toward the two ends in a drawing direction so that the two ends are lower than a center of the nozzle slot. The width changes from the center towards the two ends.

### CROSS REFERENCE TO RELATED APPLICATIONS

This application is continuation of International Application PCT/EP2022/055226 filed 2 Mar. 2023, which claims benefit of German Application 10 2021 106 106.7 filed 12 Mar. 2021, the entire contents of all of which are incorporated herein by reference.

### BACKGROUND

### 1. Field of the Disclosure

The disclosure relates to a device for drawing glass ribbons from a glass melt, wherein the device has a drawing tank for holding a glass melt, which has a nozzle with a passage opening, through which the glass melt can emerge downward, wherein the passage opening is slot-shaped and forms a nozzle slot which is curved in at least one direction in at least one side region.

### 2. Description of Related Art

Large-area production of very thin glass, for example with thicknesses of less than 250 μm, is still a particular challenge, especially when high demands are placed on surface quality, the maximum variation in thickness and a uniform width. One possibility for producing very thin glass is, for example, the production of thin glass ribbons by the “down-draw” method.

The standard down-draw method uses a slotted nozzle for the production of thin flat glass. In this case, the glass, which has been melted in a melting trough, is passed through a pipe system and fed to the drawing tank after passing through various process steps. The lower end of the drawing tank is formed by a nozzle with a slot through which the glass streams out of the drawing tank and is pulled downward by means of drawing rollers. In this case, the drawing speed is used to set the final thickness of the thin glass ribbon to be produced. The faster the glass is pulled down, the thinner it becomes. The glass thickness can also be influenced by means of the slot width.

Moreover, it is possible to set a temperature gradient at the drawing tank with which the edge temperatures at the ends of the slot should be cooler than the temperatures in the center of the slot. As a result, the downwardly pulled glass ribbon always has a higher viscosity at the outside than in the center, and this leads to spreading of the glass between the edges of the glass ribbon, referred to as borders. In this way, the width of a flat glass can be controlled and determined during production. In the case of uniform viscosity distribution across the width of the glass ribbon, constriction and thus an uncontrolled reduction in the width of the glass ribbon would occur.

However, owing to the higher viscosity in the edge region of the glass ribbon, the deformation forces increase to a greater extent than in the center of the ribbon when the drawing speed is increased in order to set a thinner glass thickness. This leads to a small increase in throughput in the edge region of the ribbon, as a result of which more glass is drawn out of the slot than would flow out without drawing forces. Owing to the nonuniform increase in throughput, the thickness distribution in the glass ribbon will change such that the edge regions become thicker in comparison with the center and the thickness distribution acquires a concave shape. Such irregularities can be evened out subsequently by means of border rollers, which are placed underneath the nozzle. During the production of extremely thin glass ribbons of less than about 250 μm, such border rollers may cause the glass ribbon to break, however.

To counter these problems, U.S. Pat. No. 1,626,382 A presented a funnel-shaped nozzle slot where the parallel slot shape was of narrower configuration at the slot ends than toward the central slot region. In contrast, the funnel shape is less pronounced at the slot ends, and as a result there is more hot glass mass available at the slot ends, and the glass cools less quickly and the temperature is kept substantially the same over the entire length of the slot. On the other hand, the narrowed slot at the slot ends is supposed to ensure a higher drawing resistance. However, such a slot shape is not very practical. On the one hand, a mechanically predetermined ratio between two different slot widths over the length of the same slot is a very specific choice and is applicable only to a very particular combination of glass composition, predefined glass thickness and an appropriate drawing force and, on the other hand, the drawing properties and thickness ratios of the glass may change even with the most minor changes in the drawing force. The nozzle should therefore be exchanged with every change in the desired glass thickness or in the case of process-related fluctuations in the drawing force, and only extremely small tolerances can be permitted, in order to achieve an optimum result. Furthermore, a combination of two different slot widths is also incapable of compensating for any gradients, and therefore it is also not possible to reliably compensate for nonuniform thickness distribution, caused by a temperature gradient, across the width of the glass ribbon.

CN 110590132 A describes a similar slot shape, wherein the nozzle slot is of parallel design in the central region and is narrowed in a nonlinear manner at the sides, the intention being to achieve a more favorable thickness distribution. However, there remains the problem that the nozzle has to be changed with every change in the glass thickness, and the temperature gradient leads to a higher viscosity at the borders.

U.S. Pat. No. 3,473,911 describes a funnel-shaped nozzle, the opening of which has a variable width. However, this is associated with a high outlay since the glass shaping process has to be interrupted for manual adjustment of this width. Moreover, the existing viscosity gradient cannot be compensated in this way.

U.S. Pat. No. 2,422,466 A also presents a nozzle, but this is funnel-shaped only in the central region. Similarly to U.S. Pat. No. 1,626,382 A, the nozzle slot is narrower at the sides than in the central region. Moreover, an additional volume is likewise made available at the sides, as a result of which the glass cools less quickly at the slot ends. However, the nozzle is not funnel-shaped at the sides but pocket-shaped. This has the effect that, although the glass cools less quickly, it can no longer flow out of the slot but has to be actively pulled. Given a standardized drawing force, there is therefore the problem that a certain quantity of glass remains in the pockets, giving rise to a nonuniform temperature distribution within the pockets. Moreover a kink in the slot has the effect that the drawing forces of the drawn glass ribbon are unequally distributed in some sections across the width of the nozzle slot. Thus, a standardized width of the glass ribbon can be achieved only with great difficulty or not at all.

### SUMMARY

It is therefore the object of the disclosure to provide a down-draw method and a device for drawing a very thin glass ribbon by means of which different glass thicknesses can be produced without major variation of the drawing tank temperatures, and it is thus also possible to compensate for process-related tolerances, and a standardized thickness and a uniform and controllable width of the glass ribbon are ensured. The intention is, by this means, to achieve more stable process management. In addition, the intention is as effectively as possible to suppress the constriction of the glass ribbon, especially at high drawing speeds.

The disclosure accordingly relates to a device for drawing glass ribbons from a glass melt. The device has a drawing tank for holding a glass melt, which has a nozzle with a passage opening, through which the glass melt can emerge downward. The passage opening is designed as a nozzle slot having two ends, wherein the length of the nozzle slot is greater than the width thereof. The nozzle slot is curved downward toward the ends of the nozzle slot, in particular throughout or continuously, i.e., in the drawing direction, in a first and a second side region, with the result that the ends are lower than a central region of the nozzle slot arranged between the ends, which, in particular, runs in a straight line, and wherein the width of the nozzle slot changes from the center toward the ends.

In particular, the nozzle slot extends over a length, a width and a height, wherein the height runs parallel to the drawing direction of the glass ribbon. The width and length each run perpendicularly to one another and to the height. The length of the nozzle slot can therefore also be understood as a length transversely to the width and height. Here, the length of the nozzle slot is greater than the width and height thereof. Where a height of the nozzle or of the nozzle slot is referred to below, this is intended to refer to the extent along the drawing direction, which is preferably counter to gravity. The height of the nozzle or nozzle slot therefore runs from an upper surface of an upper wall of the nozzle to a lower end. Accordingly, the width and length of the nozzle or nozzle slot run horizontally, that is to say, in particular, perpendicularly to the drawing direction of the glass, wherein the length of the nozzle slot is preferably given by the distance between the first end and the second end.

A change in the width of the nozzle slot can be interpreted to mean that the nozzle slot is uneven throughout or preferably of curved design along the length and with regard to its width in the first and/or second side region. “Curved downward” should be interpreted to mean that, in the first and/or second side region, the nozzle slot is designed not to be straight or, in particular, to be curved, preferably throughout, with the result that the first and/or second end are/is lower than the central region.

It should be noted that the passage opening has an outlet area through which the glass melt emerges. In particular, the nozzle slot ends in a slot-shaped nozzle opening, which preferably corresponds to the outlet area. In this case, the outlet area is arranged at a lower end of the nozzle slot and is surrounded by a lower surface of the nozzle. Like the nozzle slot, the outlet area thereof extends over a length, a width and a height parallel to the drawing direction of the glass ribbon, wherein, preferably in the central region, the outlet area extends, in particular, parallel to the length and width of the nozzle slot. In the first and/or second side region, along the length of the outlet area and with respect to its height, the outlet area ideally does not run straight or, in particular, is curved throughout, and is preferably also not straight or is, in particular, curved throughout with respect to its height. Thus, when reference is made to a shape of the nozzle slot, this is also intended to refer to the configuration of the outlet area by which the nozzle slot is defined on the lower side of the nozzle.

By changing the width of the nozzle slot, it is possible to affect the local throughput of the glass melt. It is thereby possible to adapt the throughput along the length of the nozzle slot in such a way that constriction of the glass ribbon is reduced and the useful width of the ribbon between the thickened borders is as large as possible. The constriction of the glass ribbon across the width is advantageously greatly reduced by the at least sectionwise curvature of the nozzle slot or the at least sectionwise curvature of the outlet area. In particular, the vertically downward curvature of the shape of the nozzle slot leads to improved distribution of forces during the drawing of the glass ribbon, ensuring that the glass ribbon is also drawn transversely by a horizontally acting force.

The passage opening, in particular the nozzle slot, preferably tapers from the center toward the ends, and therefore the width of the nozzle slot is greater in the central region than at the ends thereof. Tapering of the nozzle slot toward the ends advantageously leads to a reduced throughput of glass through the nozzle slot while maintaining the same viscosity of the glass over the length of the slot. However a frequently pertaining temperature gradient has the effect that the viscosity of the glass at the nozzle slot ends increases on account of the low temperature and, as a result, an increased tensile force acts on the glass, leading to an increased throughput. At the same time, this also means that the throughput at the tapered nozzle slot ends in the case of a temperature gradient can be adapted to the throughput in the central region, thus enabling a thickness of the glass ribbon which is standardized as far as possible to be achieved.

It is also advantageous if the passage opening, in particular the nozzle slot is designed to taper, preferably continuously, along the length in the direction of the lateral ends or to rise monotonically along the length from the lateral ends to the center. In this way, it is possible to set the throughput in such a way that the throughput of the glass is uniform, in particular the same, along the length of the nozzle slot in the case of a temperature gradient and thus also a viscosity gradient.

It is therefore also conceivable that the passage opening, in particular the nozzle slot in plan view or in the drawing direction, thus has an oval, elliptical, concave or lenticular shape with respect to the length and width. Here, the shape can be interpreted such that the nozzle slot forms a convex shape, that is to say is wider particularly in the center than at the ends thereof. With this shape, the nozzle slot tapers gradually or linearly or exponentially and is accordingly especially adaptable to a temperature gradient.

In an advantageous embodiment, the nozzle slot has a continuous, or preferably gradual, curvature with respect to the height, with a radius, in the first and second side regions, wherein the height runs parallel to the drawing direction. The vertically downward curvature of the shape of the nozzle slot leads to improved distribution of forces during the drawing of the glass ribbon, ensuring that the glass ribbon is also drawn transversely by a horizontally acting force. Given a continuous change in the height of the nozzle slot, the outlet area toward the nozzle slot ends is likewise continuously curved, and therefore the horizontally acting proportion of the forces rises continuously toward the slot ends. This means that, the greater the compulsion toward constriction of the glass ribbon, the more powerfully also the force counteracting the constriction acts, thus ensuring that a standardized width of the glass ribbon is achieved. Ideally, the transition from the central region, which preferably runs linearly and/or perpendicularly to the height, to the downward-curved side regions is made gradual or linear, ensuring, in particular, that no kink is formed and a gentle transition or gradual change in the acting forces is ensured. In this way, it is possible to avoid variations in the thickness and width of the glass ribbon. It is therefore also conceivable for the central region too to be curved downward, in particular slightly in the direction of the side regions or in the direction of the ends. In this case, the highest point is preferably situated in the center of the central region.

In a further embodiment, the nozzle slot has at least one of the following features: the nozzle slot is curved steadily up to the end, wherein, in particular, the nozzle slot has a steady curvature from a central region up to the end, and preferably runs in a straight line in the central region or has only a slight curvature, the nozzle slot is curved as far as the end and the curvature has an inflection point.

It is self-evident that the nozzle slot can also be of tapered design in respect of its width and height, preferably being funnel- or trough-shaped. In this case, the tapering in the width of the nozzle slot may be linear or nonlinear, in particular may be curved, in order to assist the drawing out or running out of the glass through the nozzle slot and correspondingly to reduce tensile forces that necessarily have to be expended for this purpose.

Provision can be made, in each of the first and second side regions, for the nozzle to have a projection for holding an additional through-flow volume of the glass melt, and the projection extends along the drawing direction, that is to say protrudes downward, wherein an interior space of the projection defines the magnitude of the additional through-flow volume. The projection can also be regarded as a depression at the nozzle slot ends, in particular at the first and second nozzle slot ends. This depression or this projection can be used to provide the downward-curved profile of the nozzle slot and preferably also an interior space of the projection. In this case, the interior space is preferably defined by the walls which surround the nozzle slot, i.e., walls of the nozzle, in particular walls in the lateral regions of the projections. The interior space is preferably designed to provide an additional volume for holding glass melt, wherein the walls of the interior space or nozzle slot offer a higher surface area and can thus accelerate the cooling of the glass melt. Here, the glass melt can dissipate heat via the enlarged surface area. As a result, the glass has a lower temperature as it emerges from the nozzle slot than without these projections/depressions. The lower temperature entails a higher viscosity, which suppresses severe constriction of the glass ribbon. The choice of a suitable additional volume or interior space thus enables the temperature gradient and hence also the viscosity of the glass melt to be selectively controlled.

It is also envisaged that the ratio of the height of the interior space of the projection to the width of the interior space of the projection is greater than 0.2, preferably greater than 0.5, preferably greater than 0.8 and/or less than 2, preferably less than 1.6, preferably less than 1.2. The dependency relationship is important. This is because, the smaller the width, the greater is the pressure loss that must be overcome by the inflowing glass. On the other hand, the cooling of this glass volume is not as good if the interior space is too wide since then the path for heat conduction through the glass to the cooling walls of the nozzle slot or interior space becomes longer. Such a ratio of the height to the width of the interior space is therefore the optimum ratio between pressure loss and cooling of the glass melt.

In an advantageous embodiment, the radius, in particular the minimum radius of curvature of the nozzle slot, is defined by the height of the projection and a length of the projection, with the result that the nozzle slot, in particular the outlet area, is curved downward.

It is also conceivable that the radius of curvature of the nozzle slot is greater than 100 mm, preferably greater than 130 mm, preferably greater than 160 mm and/or less than 260 mm, preferably less than 230 mm, preferably less than 200 mm. It is thereby possible to achieve optimum force displacement with a horizontal component that increases toward the ends. The mean radius is preferably between 100 mm and 260 mm. According to one embodiment, the radius decreases with increasing length of the nozzle slot, or toward the ends thereof, in particular linearly or exponentially, in order to ensure a continuous increase in the horizontal force component relative to the vertical force component. Thus, excessive constriction of the glass ribbon at particularly high drawing speeds, as used, for example, for glass ribbons with a thickness of less than 100 μm, can be prevented and the glass ribbon can be spread wide, particularly at the ends.

It is also advantageous if the ratio of the length of the projection to the height of the projection is less than 2.8, preferably less than 2.6, preferably less than 2.4. This is the optimum ratio for achieving a suitable distribution of forces. If the horizontal component is of a similar magnitude to the vertical component or even greater, i.e., the ratio of length or height of the projection is below 2.4, when the perpendicular to the nozzle slot is >=45° to the drawing direction, this has a disadvantageous effect on the width of the glass ribbon since an excessively large proportion of the horizontal component may lead to constriction.

It is also conceivable for the curved portion of the projection of the first side region to be situated opposite the curved portion of the projection of the second side region. In particular, the nozzle slot with the projections or depressions is of mirror-symmetrical design in at least one direction, but preferably in respect of its length and/or width. It is thereby possible to produce a standardized thickness and width over the entire width of the glass ribbon.

Provision can be made for the height of the interior space of the projection to be greater than 10 mm, preferably greater than 15 mm, preferably greater than 20 mm and/or less than 80 mm, preferably less than 60 mm, preferably less than 40 mm.

In an advantageous embodiment, the width of the projection is defined by the product of the width of the nozzle slot, in particular the cross section of the passage opening and a value which is greater than 1 mm, preferably greater than 1.5 mm, preferably greater than 2 mm and/or less than 15 mm, preferably less than 10 mm, preferably less than 5 mm. Both the height and the width of the projection or of the interior space of the projection define the available additional volume for holding the glass melt and thus the possibility of adjusting the temperature and viscosity of the glass. With the values given above, it is therefore possible to achieve an optimum temperature or viscosity gradient of the glass melt over the width of the nozzle slot, and therefore, given a standardized tensile force, a standardized width and thickness of the glass ribbon is also ensured.

Provision can be made for the projection to have a lower wall which closes off the interior space of the projection in the drawing direction, wherein the passage opening or outlet area is arranged in the lower wall. In addition to the lower wall, the nozzle preferably also comprises an upper wall, situated opposite the lower wall, and, particularly in the first and second side regions, lateral walls, by means of which the interior space of the projections is delimited. Ideally, the lower wall of the projections is of curved design, in particular being curved throughout or continuously, in the drawing direction thus making it possible to provide the interior space between the lower and upper wall. As a result of the curvature of the lower wall, the interior space tapers in the direction of the central region of the nozzle.

The object is also achieved by a method for drawing thin glass ribbons from a glass melt, in which glass is melted and emerges from a drawing tank, which guides the glass melt and has a passage opening, and is drawn out downward in a drawing direction to form the thin glass ribbon. The thin glass ribbon can be cooled by means of at least one cooling device after emerging from the passage opening until it falls below the glass transition temperature T_{g}. The thin glass ribbon is drawn out in the drawing direction by contact with drawing rollers which transmit tensile forces to the thin glass ribbon. The drawing rollers contact the glass at a position at which the temperature is below the glass transition temperature T_{g}. In this context, passive cooling of the glass would also be conceivable. A device described above is used for the method, wherein the device has a nozzle with projections which counteract the constriction of the glass ribbon. The nozzle with the projections is distinguished by two modes of action. On the one hand, the projections are configured in such a way that the glass melt emerges at a lower temperature toward the ends, thereby giving rise to a viscosity gradient that leads to increased viscosity of the glass melt at the ends of the nozzle and thus also to an increased tensile force on the glass ribbon. As a result, the glass ribbon is drawn more powerfully across its width. Accordingly, a temperature gradient across the width of the nozzle is generated, wherein the temperature of the glass melt decreases toward the ends.

Moreover, glass which emerges in the center of the nozzle slot travels a distance which is determined by the height of the projections until it is at the same height as the ends or endpoints of the nozzle slot. As a result, the glass coming from the center has already been cooled down somewhat when glass emerges at the same height from the end of the nozzle slot. At this point, the thin glass in the center has thus attained a higher viscosity, likewise counteracting constriction of the glass ribbon.

On the other hand, it is also envisaged that the nozzle is designed in such a way that a tensile force on the glass ribbon generated below the passage opening is divided at the projections into a vertical and a horizontal force component, wherein a deformation force acting oppositely thereto is generated in the glass ribbon and the proportion of a horizontal deformation force component relative to the proportion of a vertical deformation force component increases toward the first and the second end. In this case, the horizontal deformation force component counteracts the constriction of the glass ribbon at the borders. This horizontal deformation force component spreads the glass ribbon out in the horizontal direction, reducing the constriction. By virtue of the special shape or configuration of the nozzle slot, particularly in the side regions, the ratio of the horizontal and vertical deformation force components is controlled in a selective manner, e.g., by means of the curvature of the nozzle slot in respect of the height of the nozzle slot, preferably in respect of the height of the projections. Here, the radius of this curvature ideally decreases continuously in a linear or exponential manner toward the ends, but a gradual transition to an, in particular, horizontal and/or straight, central region of the nozzle is also explicitly ensured in order to prevent irregularities in the thickness and width of the glass ribbon.

By means of the method described and, in particular also, of the device, it is possible to produce particularly thin glass ribbons. By using the specially shaped nozzle with the nozzle slot and the projections, by means of which the tensile forces acting on the glass ribbon across the width thereof can be adjusted selectively and, in particular, in a region-specific manner, it is possible to dispense with border rollers, which can lead to tearing of the glass ribbon.

The device and the method are suitable particularly for producing thin and ultrathin glass. Thus, according to one embodiment, a thin glass ribbon with a thickness of at most 200 μm, preferably at most 100 μm, is drawn. It is also possible to draw significantly thinner glass ribbons, e.g., with a thickness of at most 70 μm, preferably at most 50 μm, particularly preferably at most 20 μm. Thicknesses of at least 5 μm, preferably at least 10 μm, are also conceivable. Such glass ribbon thicknesses are advantageous particularly with regard to multilayer flexible or pliable covers, e.g., flexible displays. The special configuration of the drawing nozzle makes it possible, in particular, to produce glass ribbons with very different thicknesses without changing the nozzle gap. In this context, it is possible to draw successive glass ribbons whose thickness differs by a factor of at least 1.5, preferably at least a factor of 2, from the same nozzle. In this way, it is possible to produce glass ribbons of different thicknesses without changing the nozzle and thus also without interrupting the production process.

### BRIEF DESCRIPTION OF THE DRAWINGS

The disclosure is explained in more detail below with reference to the appended figures. In the figures, identical reference signs in each case denote identical or corresponding elements. More specifically:

FIG. 1 shows a schematic illustration of a device for drawing glass ribbons from a glass melt.

FIG. 2 shows a schematic illustration of a nozzle slot in plan view and the thickness distribution along the width of a thin glass ribbon.

FIG. 3 shows a schematic illustration of a nozzle slot in plan view and the thickness distribution along the width of a thin glass ribbon.

FIG. 4 shows a schematic cross section of a side region of the slot with the projection.

FIG. 5 shows a schematic plan view of a nozzle.

FIG. 6 shows a schematic illustration of a side region of the nozzle with a projection and a short nozzle slot in perspective view.

FIG. 7 shows a schematic illustration of a side region of the nozzle with a projection and a short nozzle slot in perspective view.

FIG. 8 shows a schematic cross section of a side region of the nozzle with a projection.

FIG. 9 shows a schematic cross section of a nozzle.

FIG. 10 shows a schematic illustration of a device for drawing glass ribbons from a glass melt.

FIG. 11 shows a schematic view of a cooling kiln.

FIG. 12 shows a schematic view of the shaping region with heating and cooling units.

FIG. 13 shows a schematic illustration of the crucible, of the outlet pipe and of the drawing tank.

### DETAILED DESCRIPTION

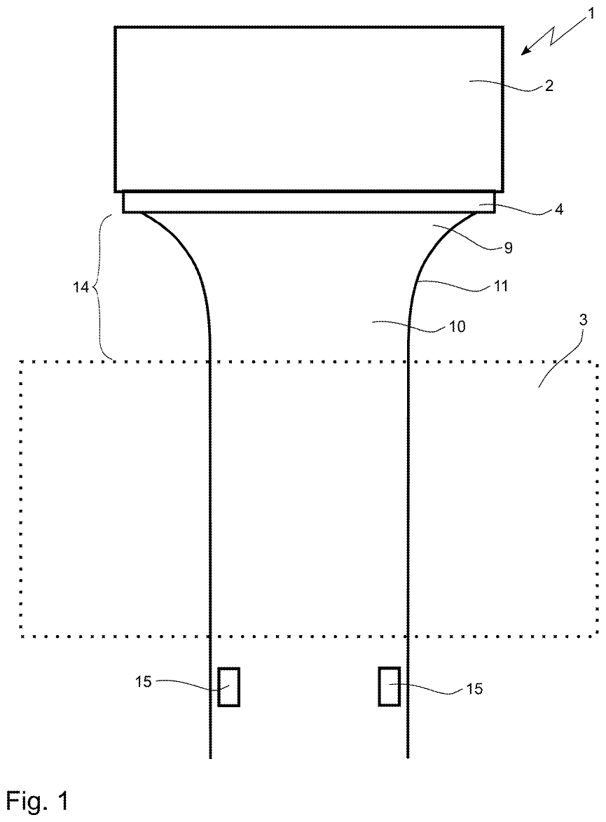

FIG. 1 shows a schematic illustration of a device 1 for drawing glass ribbons 10 from a glass melt 9. The device comprises a drawing tank 2 with a nozzle 4 arranged underneath and a cooling device 3, in which the glass ribbon 10 is cooled. The glass melt 9 is first passed into the drawing tank 2, in which temperature control takes place, or the temperature of the glass melt 9 is adjusted over the length and width of the drawing tank. The glass melt 9 then passes into the nozzle 4, through the opening of which the glass melt 9 emerges from the drawing tank 2. Even as it passes through the nozzle, but particularly at the time of exit from the nozzle, the glass melt 9 is given its final form, the glass ribbon 10, in the shaping region 14. The glass ribbon 10 is delimited at the edges by the glass ribbon edges or borders 11.

After emerging from the nozzle 4, the glass ribbon 10 is cooled in or below the shaping region 14 until it falls below the glass transition temperature T_{g}. Drawing rollers 15, by means of which tensile forces are transmitted to the glass ribbon 10, are preferably arranged below the cooling device 3, that is to say preferably in the cold region. The temperature of the glass at the point of contact with the drawing rollers is preferably at most 200° C., particularly preferably at most 100° C. Contacting the glass with drawing rollers only in the cold region, i.e., below T_{g}, particularly preferably at temperatures of at most 200° C., has proven advantageous in reducing the probability of breakage. Moreover, there is greater freedom in the selection of material for the drawing rollers at low temperatures. Thus, the drawing rollers can have an elastomer surface, which exhibits only slight slippage.

Preferably, at least two pairs of drawing rollers 15 are arranged spaced apart transversely to the drawing direction Z, wherein the pairs of drawing rollers grip the glass ribbon 10 on both sides in the region of the borders 11 in each case between two drawing rollers 15. Depending on the desired thickness of the glass ribbon 10, the tensile force transmitted by the drawing rollers 15 is adapted or adjusted. According to one embodiment, in the case of a lesser thickness, the tensile force can therefore be set higher than in the case of a desired greater thickness, that is to say a thicker glass ribbon 10. Accordingly, the glass ribbon 10 is preferably adjusted to a desired thickness by the tensile force transmitted by the drawing rollers 15 and is drawn out of the nozzle 4 as a glass melt 9.

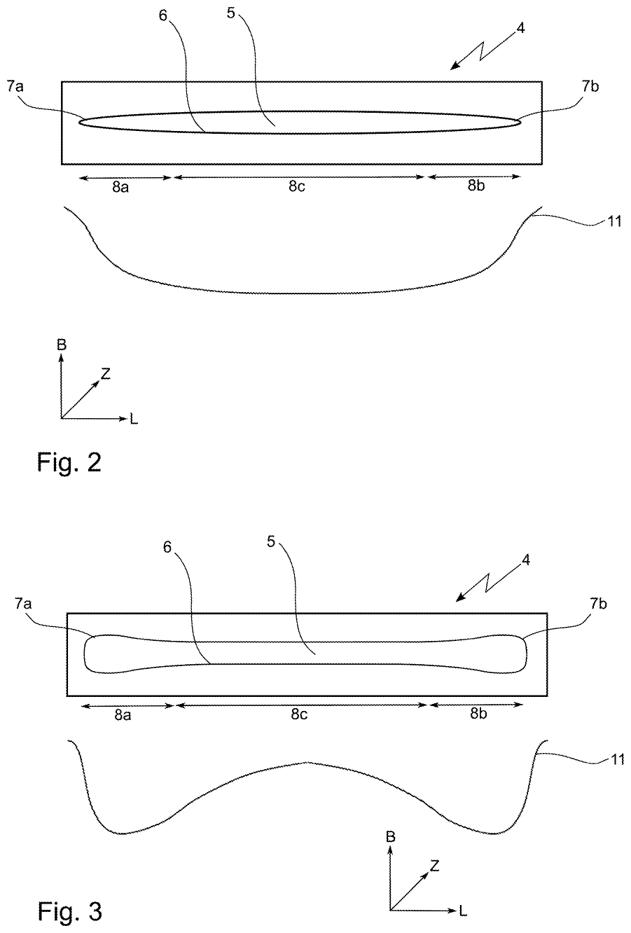

FIGS. 2 and 3 each illustrate a nozzle slot profile in plan view, as well as a typical thickness distribution along the width of a thin glass ribbon. The nozzle 4 extends along a width B, a length L and a height H along a drawing direction Z and has a preferably slot-shaped passage opening, which is designed in particular as a nozzle slot 5. The nozzle slot is surrounded by walls 6 of the nozzle 4. In this case, the nozzle slot 5 has a first end 7a and a second end 7b, wherein the first end 7a is arranged in a first side region 8a of the nozzle slot 5 and the second end 7b is arranged in a second side region 8b, and both side regions 8a, 8b extend substantially along the length L. In this case, a central region 8c is arranged between the first side region 8a and the second side region 8b.

The lower region of FIGS. 2 and 3 in each case illustrates the thickness distribution along the width of a thin glass ribbon 10 in the case of a parallel nozzle slot 5, wherein FIG. 2 shows a typical thickness distribution of a thin glass ribbon 10 with a thickness less than 300 μm and FIG. 3 shows one with a thickness greater than 300 μm. It has been found that a glass ribbon 10 with a thickness of less than 300 μm (FIG. 2) is thicker at the borders 11 than in the center between the borders. In the case of a glass ribbon 10 with a thickness greater than 300 μm (FIG. 3), on the other hand, an opposite effect is observed. Here, the maximum in the thickness distribution is in the center. This is mainly due to the different cooling behavior, or a temperature gradient of the glass ribbons 10 of different thicknesses which forms over the width, in combination with the drawing speed. In order to standardize the drawing speed or the throughput of glass through the nozzle slot 5 in the case of an existing temperature gradient of the glass melt or one deliberately brought about in the nozzle 4, the nozzle slot 5 is of curved design. Preferably, however, the temperature gradient can also be adjusted selectively in such a way that the temperature gradient runs from the center to the outside, that is to say, in particular, increases or decreases from the center to the ends 7a, 7b of the nozzle slot. In particular, the first 8a and/or second 8b side region are/is designed not to be straight or preferably to be curved throughout along the length L of the nozzle slot 5 and with respect to the height H thereof. Ideally, the nozzle slot 5 therefore has, in particular for a glass ribbon 10 with a thickness of less than 300 μm, an oval, ellipsoidal, or lenticular, or, more generally, convex cross section perpendicularly to the height in order to reduce the throughput at the edges 11. This should be interpreted, in particular, to mean that the width Bs of the nozzle slot 5 decreases from the center to the ends 7a, 7b. In the case of a glass ribbon 10 with a thickness greater than 300 μm, in contrast, a bone-shaped cross section is preferred in order to reduce the throughput in the center of the glass ribbon 10 relative to the borders 11, where a bone-shaped cross section should preferably be interpreted to mean a concave cross section, in particular in such a way that the width Bs of the nozzle slot 5 increases from the center to the ends 7a, 7b. In both cases, it is thus possible to achieve a standardized glass ribbon thickness over the width of the glass ribbon 10 or over the length L of the nozzle slot 5 by using the nozzle slot profile to regulate the throughput. The curvature preferably continues throughout or even runs continuously and, in particular, linearly or exponentially to enable uniform shaping along the length L.

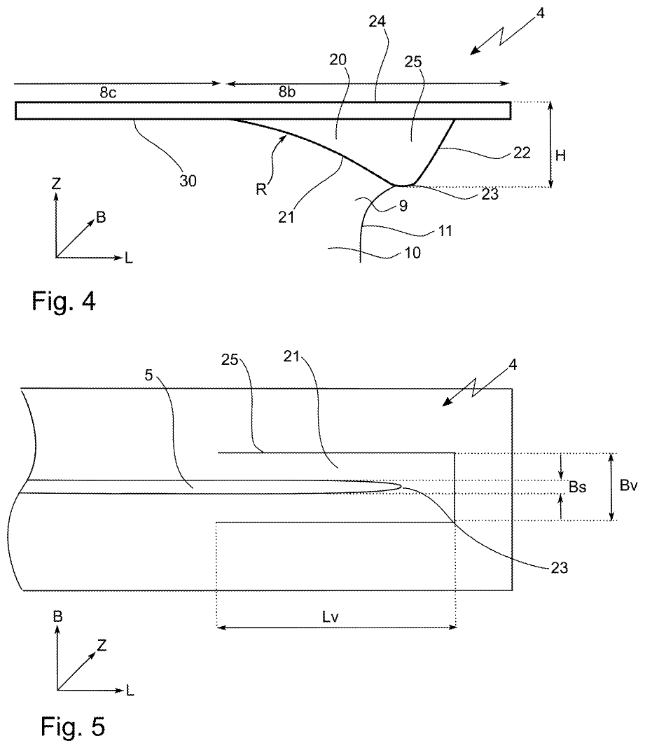

FIGS. 4 and 5 each show a schematic cross section of a side region 8b. FIG. 4 shows the side region 8b of the nozzle 4 with projection 20, wherein the projection 20 should be interpreted to be a depression in the nozzle slot 5, or as a depression which provides an additional volume for holding the glass melt 9. The projection is preferably defined by a lower wall 21, an end wall 22, and preferably also by at least one, preferably two or more, lateral walls 25. The lateral walls can be linear or curved with respect to the height H of the nozzle 4, the width By of the projection 20 and optionally also with respect to the length of the projection 20. The lower wall 21 preferably extends between the lateral walls 25 over the width By and is, in particular, limited in length by the end wall 22.

In order to achieve an effect on the forces acting during the drawing of the glass ribbon 10, however, the lower wall 21 is curved, in particular curved continuously, preferably also linearly or exponentially, along the length L and with respect to the height H. In this way, it is possible to achieve a uniformly curved profile, wherein the lower wall 21 of the projection 20 ideally forms a gentle transition to a lower boundary 30 of the central region 8c of the nozzle slot 5. In the best case, the lower wall 21 and the lower boundary 30 of the central region 8c form a single surface, and therefore the curvature of the lower wall 21 preferably begins in the side region 8b and extends as far as a lower end 23 of the projection. At the lower end 23, the lower wall 21 adjoins the end wall 22 and can be connected to the latter in one piece or as two pieces.

The lower wall 21 and/or the lower boundary 30 preferably close off the nozzle 4 or the drawing tank 2 at the bottom and, in particular, the lower boundary 30 runs horizontally. In this case, the nozzle slot is arranged in the lower boundary 30 and the lower wall 21, in particular in such a way that the glass melt 9 can flow out, or at least can be drawn out, of the lower end 23, thus enabling the glass ribbon 10 to be drawn out in terms of width at the borders 11 at the lower end 23. In terms of its length L, therefore, the nozzle slot 5 can also extend beyond the lower end, as illustrated in FIG. 7.

The height H of the nozzle 4 from the lower end 23 to an upper wall 24 of the nozzle 4, and the length Lv of the projection 20 in the side region 8a, 8b determine the radius R. In order to set the radius R of curvature of the nozzle slot 5 or of the lower wall 21 to values which, ideally, decrease toward the lower end 23, preferably between 160 mm and 200 mm, the height of the projection 20 is between 20 mm and 40 mm. A more important dependency relationship is the ratio of the height H of the nozzle 4 to the width By of the projection 20, which is also illustrated in schematic plan view in FIG. 5. The smaller the width Bv, the greater is the pressure loss that must be overcome by the inflowing glass. On the other hand, the cooling of this glass volume is not as good if the projection 20 is too wide since then the path for heat conduction through the glass to the cooling walls 21, 22 of the projection is longer. The ratio of the height H of the nozzle 4 to the width By in the interior space of the projection 20 is therefore ideally between 0.8 and 1.2. Since the nozzle slot 5 is of a substantially oval or ellipsoidal shape, the nozzle slot 5 can be defined by variation of the width Bs. Thus, for example, a difference from the center to the outsides of over 3 mm in the nozzle slot width Bs for the production of 50 μm thick glass is conceivable. In this case, the width of the nozzle slot can change both in the side region 8a, 8b, i.e., in the region of the projection 20, and in the central region 8c of the nozzle 4.

In order to define or provide an optimum interior space of the projection 20 and thereby set the viscosity of the glass melt 9, the width By of the projection 20 is calculated on the basis of the nozzle slot width Bs.

Bv=2×Bs to 5×Bs

Along the length, the projection 20 preferably extends beyond the lower end 23, and therefore the end wall 22 may run obliquely and/or in a curved manner from the upper wall 24. The upper opening in the upper wall 24 of the nozzle 4 is preferably wider and/or longer than the lower wall 21 but, in particular, wider and/or longer than the width Bs of the nozzle slot.

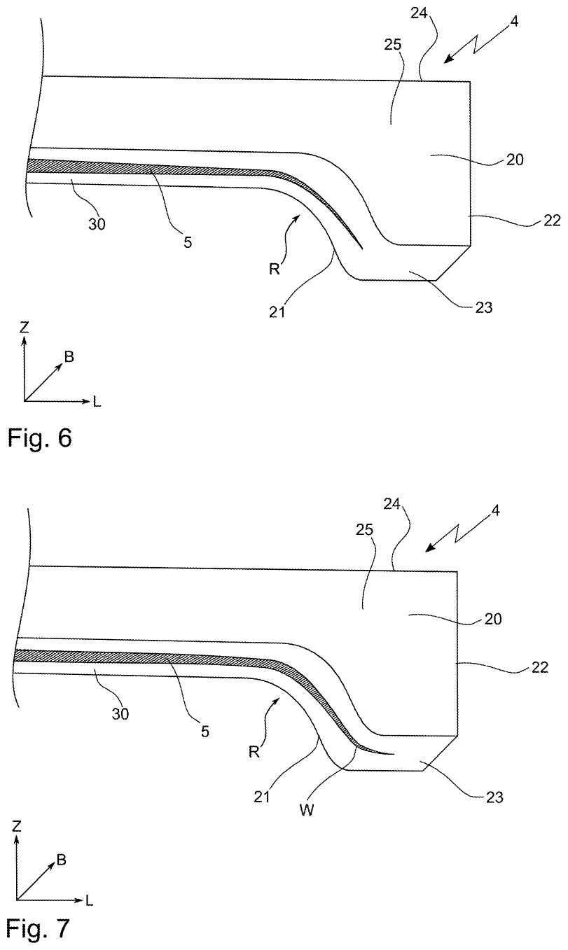

FIGS. 6 and 7 illustrate two embodiments of the nozzle slot 5 of the nozzle 4 in a perspective view. In one embodiment (FIG. 6), the nozzle slot 5 is somewhat shorter in comparison with the embodiment in FIG. 7, and therefore the nozzle slot 5 ends while it is still in the downward-curved region of the projection 20. In this embodiment, the nozzle slot 5 is therefore curved steadily downward as far as its end. In an embodiment shown in FIG. 7, the nozzle slot is somewhat longer. The nozzle slot 5 therefore extends across the lower wall 21 of the projection 20 into the lower end 23, or even beyond. The curvature of the nozzle slot 5 in the region of the transition from the lower wall 21 to the lower end 23 preferably has an inflection point W, and therefore, in particular, the slope decreases again or is even reversed. At the inflection point, the nozzle slot 5 can also have a kink.

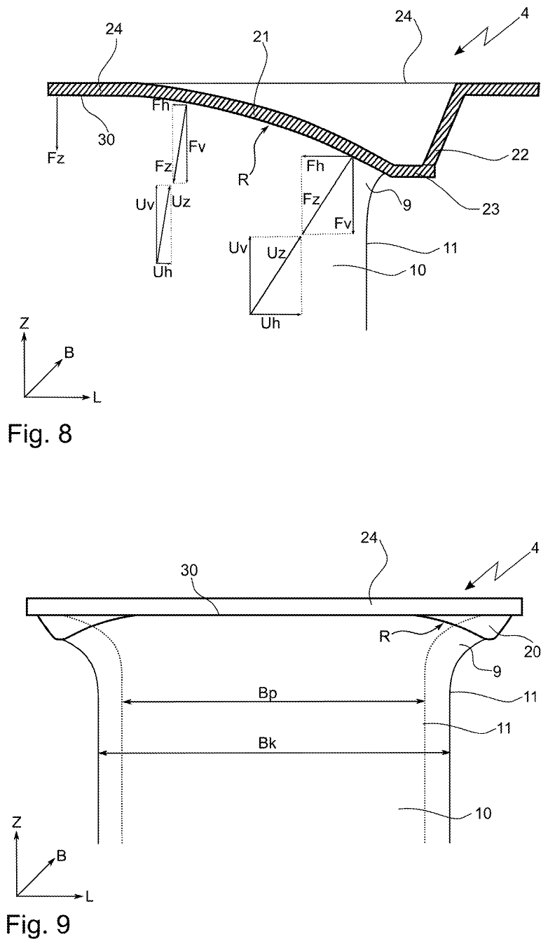

FIG. 8 shows, by way of example, the distribution of forces at the projection 20. Owing to the curvature of the nozzle slot 5, the force generated in the drawing direction by the tension of the glass ribbon 10 is divided at the projection 20 or projections 20 into a vertical Fv and a horizontal Fh force component. In the downward-curved portion 8b of the nozzle slot 5 or lower wall 21, this leads to a transverse component of the tensile force which grows continuously in the direction of the nozzle end. This means that, the smaller the radius R in the direction of the lower end 23, the greater is the horizontal proportion of the deformation force Uh during the drawing of the glass ribbon 10, which is very important for spreading out the glass ribbon 10 and keeping it spread. The reaction forces in the viscous glass result in the deformation, i.e., the thinning of the glass mass. Here, therefore, the horizontal component Uh in turn draws the glass in the process of deformation outward, particularly at the borders 11, that is to say transversely and thus also counter to the constriction, while the vertical proportion of the deformation force Uv draws the glass downward in the drawing direction Z. The forces resulting from the sum of the horizontal and vertical force components are indicated as Fz for the tensile force and Uz for the deformation force in the glass ribbon 10.

Depending on the desired width of the glass ribbon 10 and/or the tensile force, the radius R of curvature of the nozzle slot 5 may also be the same, i.e., may preferably not decrease in the direction of the lower end. However, it is particularly important that no “kink” is formed at the transition from the lower wall 21 to the lower boundary 30 of the central region 8c since a “kink” leads to a more or less punctiform nonuniform, or unequal, distribution of forces. Particularly a nonuniform distribution of the deformation forces Uh and Uv can lead to local changes in the thickness or width of the viscous glass, and it is therefore no longer possible to ensure a stable deformation process or parameters or glass properties that are the same across the width of the glass ribbon 10.

With the nozzle 4 having the nozzle slot 5 curved in length L, width B and height H, it is possible overall to produce wider glass ribbons from a given drawing tank width than would be possible without the curvatures. It is even possible to draw glass thicknesses of less than 100 μm and even less than 50 μm. FIG. 9 illustrates, by way of example, a change in the width of the glass ribbon 10 produced by the curved slot, in comparison with a nozzle slot 5 running parallel in all directions. Here, the dashed border line 11 indicates the width Bp of a glass ribbon 10 produced with a parallel nozzle slot 5, and the solid border line 11 indicates the width Bk of a glass ribbon 10 that can be produced using the curved nozzle slot 5. Purely by way of example, a number of typical figures for the gross widths of a glass ribbon 10 of different thicknesses produced using a nozzle slot 5 with a length of 700 mm, and the possible change in the width when using a curved nozzle slot 5, are indicated below.

TABLE 1
Change in the width of the glass ribbon when
using a nozzle slot with projections.

| Glass thickness | Width without projection | Width with projection |
|---|---|---|
| (μm) | (mm) | (mm) |
| 1000 | 560 | 640 |
| 500 | 490 | 620 |
| 100 | 400 | 590 |

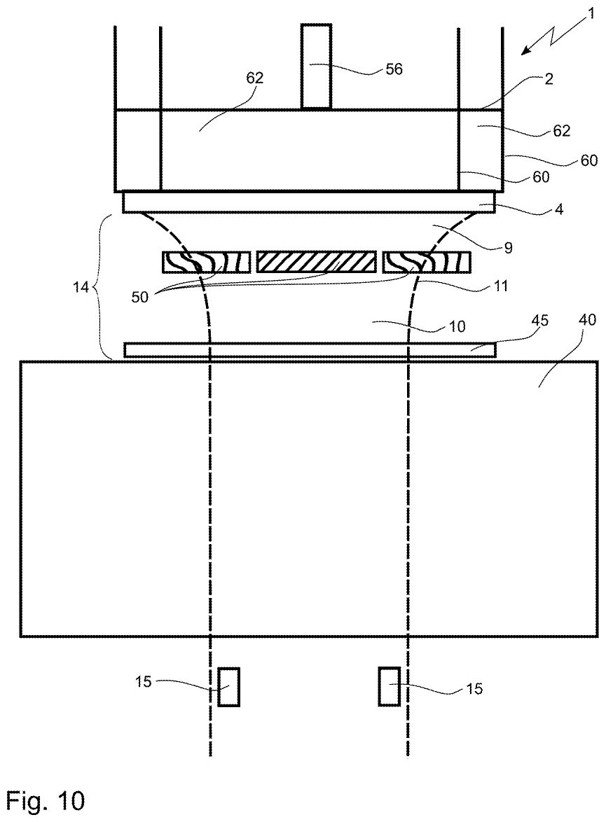

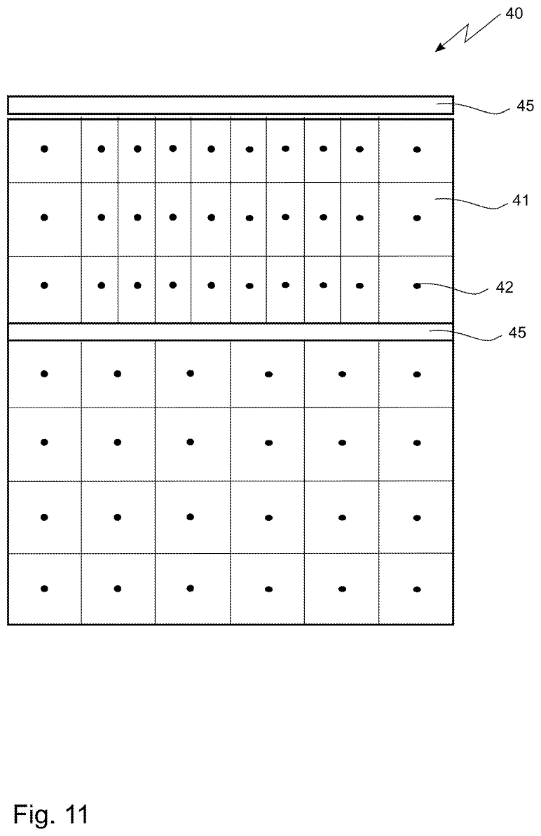

In comparison with the embodiment of the device 1 illustrated in FIG. 1, FIG. 10 shows a schematic illustration of a device 1 having other embodiments in respect of the cooling device 3 and/or the drawing tank 2. According to one of these embodiments, the cooling device 3 has at least one cooling kiln 40, through which the glass ribbon 10 is moved, in particular through an inlet and an outlet opening of the cooling kiln 40. The cooling kiln 40 is preferably arranged below the shaping region 14 of the glass ribbon 10, in particular in order to cool the shaped glass ribbon 10 to a desired temperature, e.g., room temperature, after the shaping process, in particular also to cool it slowly and in a controlled manner in order, for example, to avoid or reduce stresses in the glass ribbon 10.

For particularly precise cooling across the width of the glass ribbon 10, provision can be made for the cooling kiln 40 to have a plurality of cooling and/or heating sections 41, which are arranged side-by-side/one below the other and preferably adjacent to one another. At least one cooling and/or heating section 41, preferably a plurality of such sections, more preferably all the cooling and/or heating sections 41 comprise/comprises a thermocouple 42 for measuring and controlling the temperature. The cooling and/or heating sections 41 are preferably tile-shaped and, in particular, are arranged side-by-side in the manner of tiling. This should be interpreted to mean that the cooling and/or heating sections are designed as tiles, or shaped as rectangles, squares or hexagons, in particular such that the cooling and/or heating sections 41 can be arranged adjacent to one another without any free space in between. Such an embodiment is illustrated in FIG. 11, for example. Provision can be made for the cooling and/or heating sections 41 to be of different sizes. Thus, for example, cooling and/or heating sections 41 which, in particular, are arranged in the region of the borders 11 or the cooling kiln edges can be designed to be larger or smaller than those which are arranged in the center of the cooling kiln 40 or of the glass ribbon 10. In this way, it is possible to cool and/or heat certain regions of the glass ribbon 10 more strongly or less strongly locally in order to be able to provide the possibility of tailored cooling and/or heating for each width of glass ribbon and shape of glass ribbon. It is therefore also conceivable for cooling and/or heating sections 41 to be designed to be larger or smaller in a lower region of the cooling kiln 40 than in the upper region of the cooling kiln 40.

To control the temperature of the glass ribbon 10, it is envisaged that the device 1 has at least one temperature measuring device 45. In particular, the temperature measuring device 45 is designed in such a way that the temperature of the glass ribbon 10 can be detected or measured across the width, preferably the entire width, of the glass ribbon. As shown in FIG. 10, the temperature measuring device 45 can be arranged in the shaping region 14, in particular above the cooling kiln 40, thus making it possible, for example, to detect the temperature of the glass ribbon 10 before it is cooled by means of the cooling kiln 40. In this way, it is possible to achieve a cooling program which is the optimum for the glass ribbon 10. It is likewise also possible for the temperature measuring device 45 or at least one or more further temperature measuring devices 45 to be part of the cooling kiln 40 and/or to be arranged within the cooling kiln, e.g., centrally.

In some cases, e.g., when a nozzle 4 that is optimized for a particular glass thickness is used for the production of a different glass thickness, it may be necessary to control the temperature of the glass ribbon 10 as early as the shaping region 14. In another embodiment, the device 1 therefore has at least one, in particular a plurality of spatially distributed, cooling and/or heating units 50, which are preferably arranged in the shaping region 14. In this case, the cooling and/or heating units 50 can be configured in such a way that the cooling and/or heating units 50 can each heat and/or cool the glass ribbon 10 locally, at least in some region or regions, in a selective manner, thus enabling the width of the glass ribbon 10 to be selectively set in the shaping region 14. This means that the cooling or heating does not take place across the entire width of the glass ribbon 10 but that the temperature of the glass ribbon 10 can be varied locally in desired regions. It is thus possible to implement nonhomogeneous and/or homogeneous cooling or heating across the width of the glass ribbon.

It is therefore a particular preference that different heating and/or cooling units 50 be arranged in a spatially distributed manner, in particular in a manner distributed transversely to the glass ribbon 10, to enable control to be exerted over the local distribution of glass in the glass ribbon 10 and also to enable relatively small adjustments of the distribution of glass to be performed. In this case, the heating and/or cooling units 50 are, for example, arranged in a manner distributed over the entire area of the shaping region 14, preferably at a height greater than 5%, preferably greater than 10%, preferably greater than 15% and/or at a height less than 50%, preferably less than 30%, of the length of the shaping region 14, wherein the length of the shaping region 14 is, in particular, transverse to the width of the glass ribbon 10. Here, the length of the shaping region 14 can be between 100 mm and 300 mm. In other words, the heating and/or cooling units 50 can be arranged between the nozzle 4 and the cooling kiln 40, thus enabling fine adjustment of the thickness of the glass ribbon 10, for example. This also makes it possible to use a single nozzle slot 5 to draw different glass ribbons with a wider range of different glass thicknesses than the range for which the nozzle slot 5 is actually optimized.

In this way, it is possible, in the case of relatively thin glass with a concave thickness distribution in the center of the glass ribbon 10, for example, to use different heating and/or cooling units 50 to lower the glass temperature or increase the viscosity of the glass. As a result, shaping is ended earlier, and the glass is not drawn out as thinly in this region as would be the case without these heating and/or cooling units 50. In order to be able to regulate the temperature in a tailored manner at desired positions of the glass ribbon 10, it is conceivable for a plurality of heating and/or cooling units 50 to be arranged along, or, with respect to the width of the glass ribbon 10, side-by-side, and/or diagonally, or transversely. It is likewise possible for a plurality of heating and/or cooling units 50 to be arranged one below the other, in particular in the drawing direction. Depending on the application, provision may be made for between two and six heating and/or cooling units 50 to be arranged side-by-side, one below the other and/or diagonally with respect to one another.

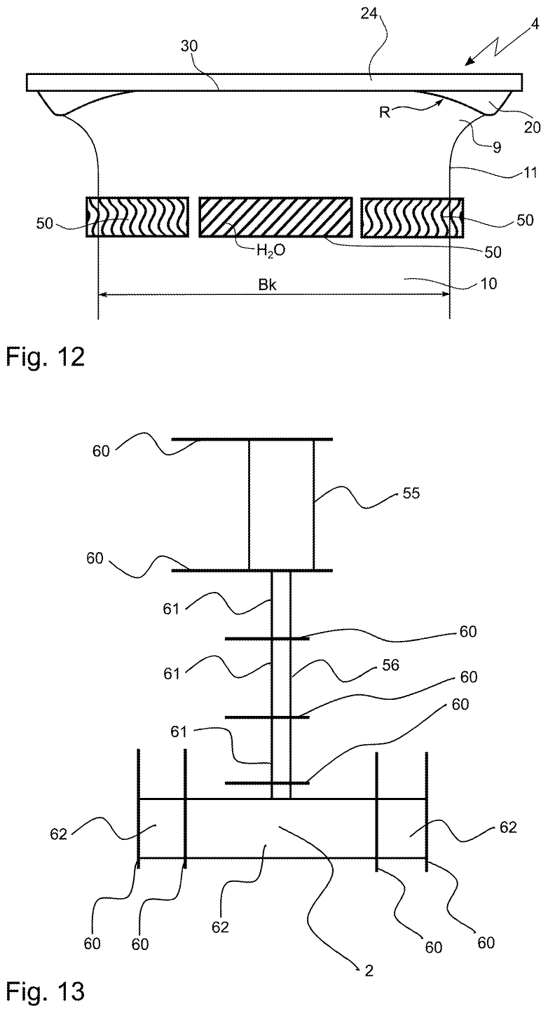

As an advantageous possibility, the heating and/or cooling units 50 can each be designed as air or water coolers and, in particular, can generate an air flow, water jet, water droplets, mist and/or an aerosol, as illustrated schematically in FIG. 12, for example. These media can be directed, in particular locally, and optionally directly, at the glass ribbon 10.

However, it is also possible for the heating and/or cooling units 50 to be designed as indirect heating and/or cooling units 50, e.g., as closed conduit systems in which at least one medium circulates, ensuring, in particular, that the glass ribbon 10 does not have any contact with another medium, e.g., water. In this case, heating and/or cooling units 50 are designed in such a way that they each emit or absorb thermal energy, or can carry away thermal energy. It is conceivable for at least one conduit of such a conduit system to be aligned transversely or parallel to the drawing direction. In order to detect the temperature, preferably of the medium and/or of the glass ribbon, it is possible to provide a temperature measuring device 45 which, in particular, is arranged at at least one, preferably at each, heating and/or cooling unit 50, thus making it possible, for example, also to measure the thermal energy removed from the glass ribbon 10. Without limitation to the abovementioned embodiments, it is also possible to use a combination of direct and indirect heating and/or cooling units 50. Irrespective of whether the heating and/or cooling units 50 cool or heat indirectly or directly, it is possible to conceive of different shapes of the cross sections of the heating and/or cooling units 50, e.g., a round, oval or a polygonal shape, such as a rectangle or a hexagon.

In this case, it is possible in each case to vary the distance between a heating and/or cooling unit 50 and the glass ribbon 10. Fine adjustment of, for example, cooling by air cooling can thus be made possible by adjustment of the air volume. In this case, the glass becomes thicker, the greater the air volume passed through per unit time. Another, very effective variant of air cooling is to add atomized water, resulting in the formation of an aerosol. Depending on the water volume, this aerosol can transport significantly more thermal energy than pure dry air, wherein the aerosol or atomized water or some other atomized liquid can also be mixed with air or a special gas composition for effective cooling.

When using a heating and/or cooling unit 50, e.g., in the form of a water and/or air cooler, its position or distance from the glass ribbon 10 can be varied. In this case, the glass becomes thicker, the smaller the distance between the water cooler and the glass ribbon 10. Heating units have the same effect, only in reverse, enabling the glass ribbon 10 to be made thinner in desired regions. In this case, the heating units can be designed as air and/or heating-coil-based heating units. To enable the heating and/or cooling units 50 to be set precisely, it is possible to provide a temperature measuring device 45, which is arranged between the nozzle 4 and the heating and/or cooling units 50.

In another embodiment, the device 1 has a crucible 55 for holding and homogenizing refined glass, on which preferably at least one outlet pipe 56 with a specially adapted diameter, which, in particular, opens into the drawing tank 2, is arranged. The glass can thus be transported from the crucible 55 into the drawing tank 2 through the outlet pipe 56. In this case, the device can have at least one, preferably a plurality or even a multiplicity of, heating elements 60, wherein at least one heating element 60 is arranged at least on the drawing tank 2, the outlet pipe 56 and/or the crucible 55. In accordance with the example shown in FIG. 13, it is also possible to arrange a plurality of heating elements 60 on the drawing tank 2, the outlet pipe 56 and/or the crucible 55, respectively, to enable the temperature and distribution of the glass in the drawing tank 2 to be precisely set.

For the purposes of the disclosure, heating elements 60 are understood to be apparatuses which are suitable and provided for the purpose of outputting energy to the drawing tank 2, the outlet pipe 56 and/or the crucible 55 and/or the contents thereof. This energy can be output in the form of thermal energy, for example, or else electrical energy or, for example, magnetic energy. In this case, the heating elements 60 can have one or more heating coils and/or flanges, which can surround the drawing tank 2, the outlet pipe 56 and/or the crucible 55 at least partially or completely in at least one direction. In general, the drawing tank 2, the outlet pipe 56, the crucible 55 and/or the contents thereof can therefore be heated directly by means of thermal energy supplied by the heating elements 60, or the drawing tank 2, the outlet pipe 56 and/or the crucible 55 can be brought to self-heating by, for example, induction or power supply, preferably by means of at least one or more, in particular, flanges. It is conceivable here that a flow of current through the drawing tank 2, the outlet pipe 56 and/or the crucible 55 is generated by means of at least two flanges, or at least one flange is used to generate a magnetic field which supplies the drawing tank 2, the outlet pipe 56 and/or the crucible 55 with energy by induction. The drawing tank 2, the outlet pipe 56 and/or the crucible 55 can therefore advantageously comprise a heat- and/or current-conducting material, e.g., a metal. In general, heating by means of the heating elements 60 can be performed, in particular, indirectly and preferably over a relatively large area and thus the formation of glass defects, for example, can be reduced. Fine adjustment of the temperature, in particular locally, is also possible.

Without limitation to the example in FIG. 13, it is envisaged that respective heating elements 60 be arranged on the crucible 55, at the upper inlet opening and the lower outlet opening, thus enabling the glass to be introduced into the outlet pipe 56 at the desired temperature. The outlet pipe 56 has three heating elements 60, wherein one heating element 60 is arranged in the upper third, one in the central third and one in the lower third. In this way, the outlet pipe 56 is preferably divided into two to four electric heating circuits 61, in particular in such a way that very fine temperature adjustment is possible and the glass can be distributed uniformly even as it runs into the drawing tank.

In another embodiment, the drawing tank 2 has a plurality of, in particular at least four, heating elements 60, preferably in such a way that the heating of the drawing tank 2 is divided preferably into three electric heating circuits. The heating circuits can also be interpreted as zones of the heating tank 2 which are arranged differently, in particular in terms of space, or perform heating in different ways and which, for example, can each heat defined volume regions of the glass in the drawing tank. In this case, the heating circuits 62 of the drawing tank 2 are preferably arranged in series as regards the length L of the nozzle slot 5 in order to control the glass distribution in the drawing tank 2 in the transverse direction or along the length L of the nozzle slot 5. Thus, the glass distribution at the nozzle slot 5 and the throughput of the glass volume at the nozzle 4 can be adjusted by means of the temperature management of the outlet pipe 56 and of the drawing tank 2. The heating elements 60 are preferably arranged in such a way that at least two or three, in particular a plurality of, heating circuits 62 are formed. In this case, at least two of the heating circuits 62 and/or heating elements 60 can be arranged laterally with respect to the drawing tank 2, in particular in such a way that at least three heating circuits 62 are formed, of which at least one further heating circuit 62 is arranged centrally with respect to the drawing tank 2. In this case, each heating circuit 62 can be surrounded, or delimited or enclosed, by at least two heating elements 60.

Therefore, the object can also be achieved in general, without restriction to specific features of particular embodiments, by a device 1 for drawing glass ribbons 10 from a glass melt 9, wherein the device 1 has a crucible 55 for holding a melt consisting of refined glass and an outlet pipe 56 for conveying the glass melt into a drawing tank 2, wherein at least the drawing tank 2 has a plurality of heating elements 60, which are preferably arranged transversely with respect to a length L of a nozzle slot 5 of a nozzle 4 through which the glass melt 9 can emerge downward, wherein the device 1 has at least one, in particular a plurality of, cooling and/or heating units 50, which are arranged in the shaping region 14. In this embodiment too, the nozzle slot 5 is preferably curved downward in the drawing direction Z toward the ends 7a, 7b of the nozzle slot 5 in a first 8a and a second 8b side region, in particular throughout or continuously, and therefore the ends 7a, 7b are lower than a central region 8c of the nozzle slot 5 arranged between the ends 7a, 7b. In order to homogenize the glass, a stirring unit can be provided in the crucible 55, in particular the number of revolutions of which per unit time is adjustable.

### LIST OF REFERENCE SIGNS

1 device for drawing glass ribbons
2 drawing tank
3 cooling device
4 nozzle
5 nozzle slot
6 walls of the nozzle or nozzle slot
7a first end
7b second end
8a first side region of the nozzle slot
8b second side region of the nozzle slot
8c central region of the nozzle slot
9 glass melt
10 glass ribbon
11 borders
14 shaping region
15 drawing rollers
20 projection
21 lower wall of the projection
22 end wall of the projection
23 lower end of the projection
24 upper wall of the nozzle
25 lateral walls
30 lower boundary of the central region
40 cooling kiln
41 cooling and/or heating sections
42 thermocouple
45 temperature measuring device
50 cooling and/or heating units
55 crucible
56 outlet pipe
60 heating elements
61 heating circuit of the outlet pipe
62 heating circuit of the drawing tank
B width
Bk width of a glass ribbon produced with a curved nozzle slot
Bp width of a glass ribbon produced with a parallel nozzle slot
Bs width of the nozzle slot
By width of the projection
H height of the nozzle/height of the projection
L length of the nozzle slot
Lv length of the projection
R radius of curvature
W inflection point of the curvature
Z drawing direction

What is claimed is:

1. A device for drawing glass ribbons, comprising:
a drawing tank for holding a glass melt; and
a nozzle in the drawing tank, the nozzle having a nozzle slot through which the glass melt emerges downward, wherein the nozzle slot has two ends, a length, and a width, the length being greater than the width,
wherein the nozzle slot is curved downward toward the two ends in a drawing direction so that the two ends are lower than a center of the nozzle slot, and
wherein the width changes from the center towards the two ends.

2. The device of claim 1, wherein the width tapers from the center toward the ends so that the width is greater in the center than at the two ends.

3. The device of claim 1, wherein the nozzle slot has a height that runs parallel to the drawing direction and has first and second side regions.

4. The device of claim 3, wherein the nozzle has a projection in each of the first and second side regions, wherein the projection has a volume configured to hold the glass melt, the projection extending along the drawing direction, wherein the volume is defined by an interior space of the projection.

5. The device of claim 4, further comprising a radius of curvature defined by a height of the projection and a length of the projection.

6. The device of claim 4, wherein the projection has a first ratio of a length of the projection to a height of the projection that is less than 2.8.

7. The device of claim 4, wherein the projection has a ratio of a height of the interior space to a width of the interior space that is greater than 0.2 and less than 2.

8. The device of claim 7, wherein the height of the interior space is greater than 10 mm and less than 80 mm.

9. The device of claim 3, wherein the nozzle slot has a curvature in the first and second side regions.

10. The device of claim 9, wherein the curvature has a radius that is greater than 100 mm and less than 260 mm.

11. The device of claim 3, wherein the projection of the first side region has a first curved portion that is situated opposite to a second curved portion of the projection of the second side region.

12. The device of claim 4, wherein the width of the projection is based on the width of the nozzle slot, and wherein the width of the projection is greater than 1 mm and less than 15 mm.

13. The device of claim 4, wherein the projection has a lower wall that closes off the interior space in the drawing direction.

14. The device of claim 1, wherein the nozzle slot has a feature selected from a group consisting of: a curvature up to the two ends, a curvature to the two ends, a curvature with an inflection point, and any combinations thereof.

15. The device of claim 1, wherein the nozzle slot has a shape selected from a group consisting of oval, elliptical, concave, and lenticular in plan view.

16. The device of claim 1, further comprising a plurality of heating elements arranged on the drawing tank, the plurality of heating elements being divided into different electrical heating circuits.

17. The device of claim 1, further comprising a ribbon shaping region and a plurality of temperature controlling devices, the plurality of temperature controlling devices being spatially distributed in the shaping region.

18. A method for drawing thin glass ribbons, comprising:
providing a glass melt of glass in a drawing tank;
drawing the glass melt downward from a nozzle in a drawing direction to form a thin glass ribbon, the nozzle having a nozzle slot with first and second side regions and a projection extending along the drawing direction in each of the first and second side regions, wherein the projection has a volume configured to counteract constriction of the thin glass ribbon;
cooling the thin glass ribbon after emerging from the passage opening until the thin glass ribbon falls has a temperature below a glass transition temperature of the glass; and
contacting the thin glass ribbon with drawing rollers that transmit tensile forces to the thin glass ribbon in the drawing direction, wherein the drawing rollers contact the glass at a temperature of the glass below the glass transition temperature.

19. The method of claim 18, wherein the tensile forces are divided at the projection into a vertical and a horizontal force component and a deformation force acting opposite to the tensive forces is generated in the glass ribbon.

20. The method of claim 18, wherein the thin glass ribbon has a thickness of not more than 70 μm.
